(19) United States
(12) Patent Application Publication
(10) Pub. No.: US 2014/0171070 A1
(43) Pub. Date: Jun. 19, 2014

(54) EXPANDED NEIGHBOR LIST FOR CELL RESELECTION

(71) Applicant: QUALCOMM INCORPORATED, San Diego, CA (US)

(72) Inventors: Shiau-He Tsai, San Diego, CA (US); Qingxin Chen, Del Mar, CA (US); Tom Chin, San Diego, CA (US)

(73) Assignee: QUALCOMM Incorporated, San Diego, CA (US)

(21) Appl. No.: 13/716,865

(22) Filed: Dec. 17, 2012

(51) Int. Cl. H04W 36/00

(52) U.S. Cl. CPC H04W 36/0083
USPC 455/434

(57) ABSTRACT

A user equipment (UE) may expand a neighbor list available to the UE to avoid neighbor information error caused by an unexpected leakage of distant time division synchronous code division multiple access (TD-SCDMA) cells. The neighbor list, may be expanded by combining previously received neighbor information with currently received neighbor information. In some instances, a new serving cell may be selected from the previously received neighbor list instead of the currently received neighbor list.

### BACKGROUND

1. Field

Aspects of the present disclosure relate generally to wireless communication systems, and more particularly, to expanding a neighbor list for cell reselection.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes maintaining an expanded neighbor list by combining previously received neighbor information with currently received neighbor information.

According to another aspect of the present disclosure, an apparatus for wireless communication includes means for receiving a current neighbor information. The apparatus may also include means for maintaining an expanded neighbor list by combining previously received neighbor information with currently received neighbor information.

According to one aspect of the present disclosure, a computer program product for wireless communication in a wireless network includes a computer readable medium having non-transitory program code recorded thereon. The program code includes program code to maintain an expanded neighbor list by combining previously received neighbor information with currently received neighbor information.

According to one aspect of the present disclosure, an apparatus for wireless communication includes a memory and a processor(s) coupled to the memory. The processor(s) is configured to maintain an expanded neighbor list by combining previously received neighbor information with currently received neighbor information.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE 350 in a telecommunications system.

FIG. 4 illustrates a geographical area with coverage from three radio access technologies according to one aspect of the present disclosure.

FIG. 5 is a block diagram illustrating a cell reselection method in which neighbor lists are expanded according to one aspect of the present disclosure.

FIG. 6 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

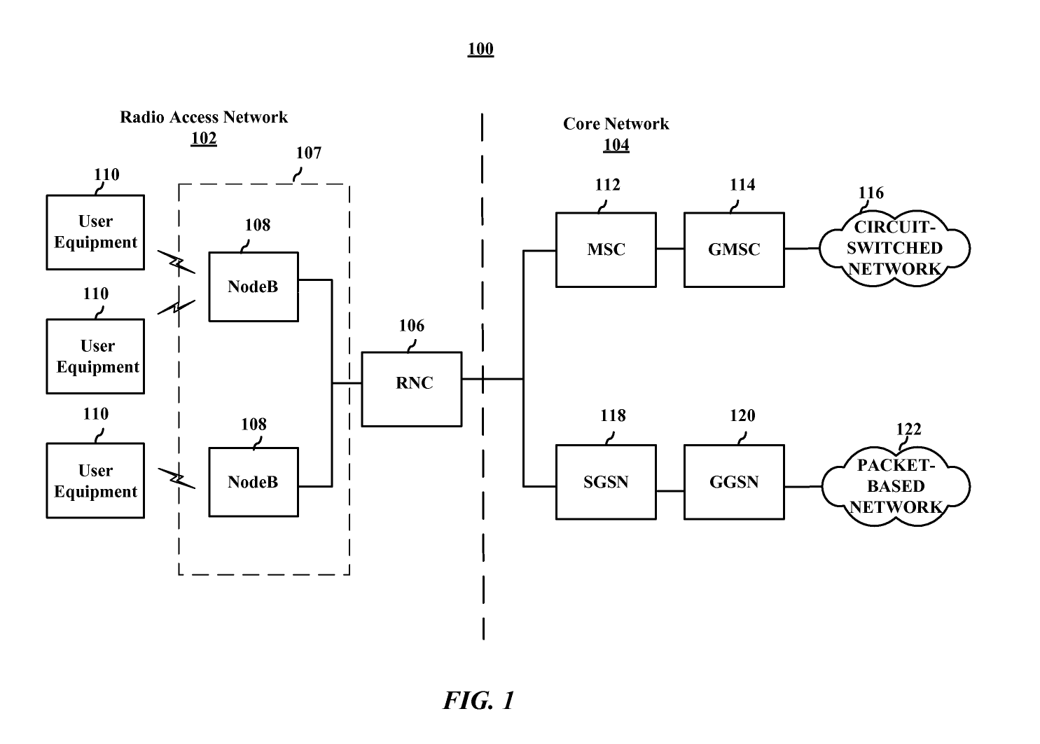

Turning now to FIG. 1, a block diagram is shown illustrating an example of a telecommunications system 90. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

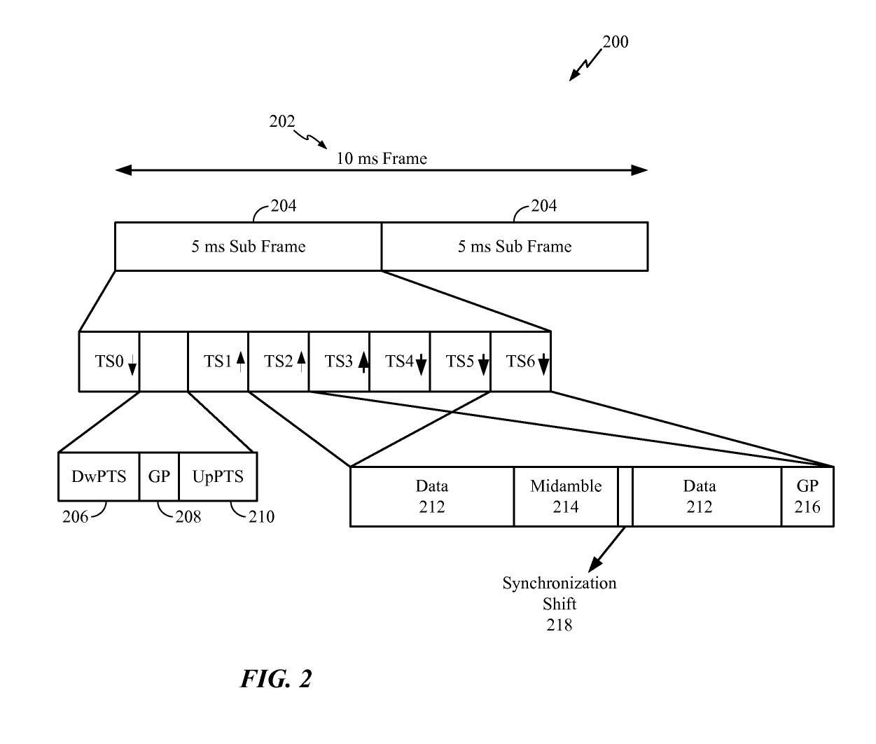

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

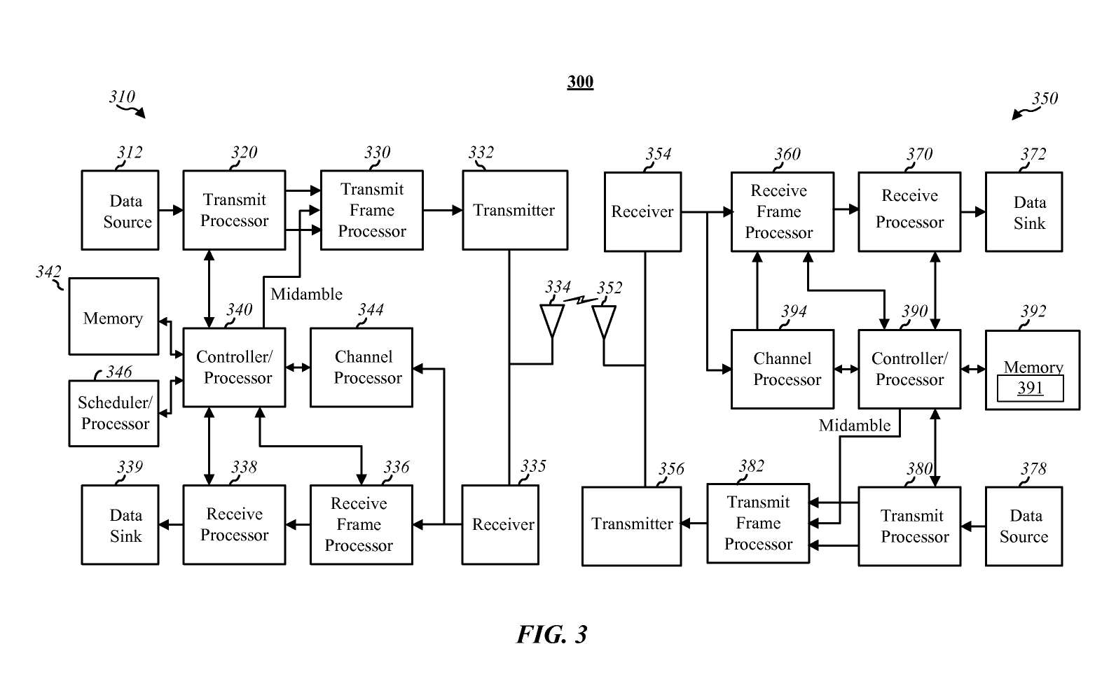

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

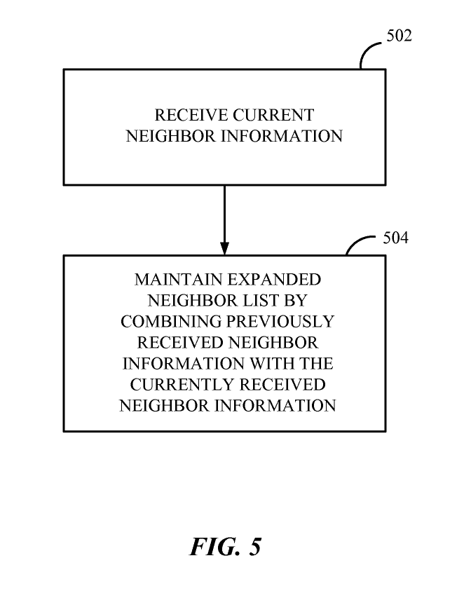

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The processor 340/390 and/or other processors and modules at the node B 310/UE 350 may perform or direct the execution of the functional blocks illustrated in FIG. 5. The computer readable media of memories 342 and 392 may store data and software for the node B 310 and the UE 350, respectively. For example, the memory 392 of the UE 350 may store a neighbor list expanding module 391 which, when executed by the controller/processor 390, configures the UE 350 for neighbor cell measurement as described. A scheduler/processor 346 at the node B 310 may be used to allocate resources to the UEs and schedule downlink and/or uplink transmissions for the UEs.

### Expanded Neighbor List for Cell Reselection

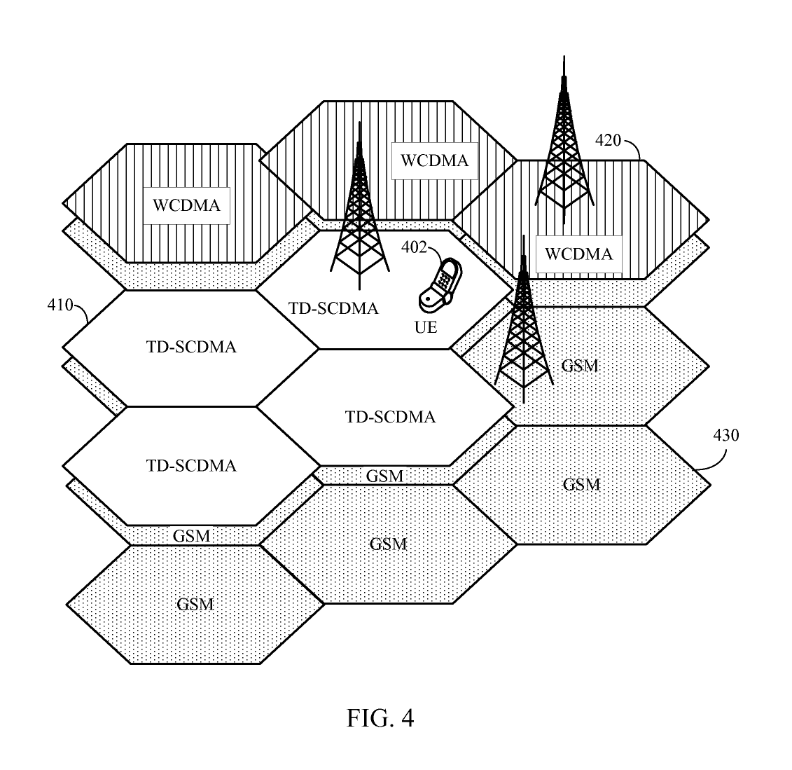

Deployment of a TD-SCDMA network may not provide complete geographic coverage in certain areas during the migration from legacy radio access technologies (RATs) to newer ones, e.g., from 2G to 3G or from 3G to 4G. In areas where TD-SCDMA networks are deployed, other networks (such as WCDMA and Global System for Mobile Communications (GSM)) may also have a geographical presence. FIG. 4 illustrates a geographical area with coverage from three radio access technologies according to one aspect of the present disclosure. In this example network deployment, the UE 402 may be in the vicinity of the TD-SCDMA network 410 but may continue to perform inter-radio access technology (inter-RAT) measurement of other radio access technologies, e.g., a GSM 430, WCDMA 420 or LTE network (not shown). This measurement may be implemented for a cell or base station reselection procedure from the TD-SCDMA cell to the GSM/WCDMA/LTE cell. Inter-RAT measurement may be implemented, for example, due to limited coverage of TD-SCDMA or when the UE desires a better RAT, e.g., LTE, for higher data rate during transmission.

A first network coverage area 410 partially overlaps with a second network coverage area 420 and a third network coverage area 430. In one aspect, the first network coverage area 410 is a TD-SCDMA network, the second network coverage area 420 is a WCDMA network, and the third network coverage area 430 is a GSM network. Other network configurations are possible.

Generally, the different networks may have certain advantages and disadvantages. For example, the GSM network 430 provides matured circuit-switched services, which is advantageous for voice calls. That is, the GSM network 430 may offer more network coverage to allow un-disrupted voice call services in handovers. As another example, the WCDMA network 420 and the TD-SCDMA network 410 provide high performance packet-switched services, which is advantageous for data calls. That is, the WCDMA network 420 and the TD-SCDMA network 410 may offer higher data rates for data call services.

When the coverage of a radio access technology (RAT), such as the TD-SCDMA network, is only a subset of another RAT, such as GSM network, mobility of the UE may result in service interruption due to inter-RAT system change. In the illustration of FIG. 4 where the TD-SCDMA network overlaps with the GSM network, the GSM network coverage is considered ubiquitous while TD-SCDMA network coverage may be less reliable due to its shorter history of deployment. Smoothly transitioning from the TD-SCDMA network to the GSM network relies on accurate GSM neighbor information when a UE is at a coverage boundary of the TD-SCDMA network. The GSM neighbor information may be broadcasted in a TD-SCDMA system information block 11 (SIB-11) for idle mode and provided in a measurement control message during traffic. The GSM neighbor information may include a list of GSM neighbor cells camped around or in close proximity to a serving TD-SCDMA cell.

A UE may use the neighbor information for GSM cell reselection when the UE moves away from the TD-SCDMA network coverage and enters GSM network only coverage areas. However, due to radio propagation anomalies that are unaccounted for during network planning, a current neighbor information received by the UE may not reflect a current set of GSM neighbor cells camped around the UE. For example, a random reflector may cause unexpected leakage of a distant TD-SCDMA cell having neighbor information corresponding to distant GSM neighbor cells rather than actual GSM neighbor cells camped around the serving TD-SCDMA cell. If the serving and the distant TD-SCDMA cells are received through non-identical multipath fading, the UE may reselect to the distant TD-SCDMA cell that is provisioned with the distant GSM neighbor cells that are far away from the coverage boundary of the serving TD-SCDMA cell. As a result, when the UE moves away from the TD-SCDMA network coverage area while camped on the distant TD-SCDMA cell, the UE's reselection to a GSM neighbor cell may not be optimal. The unexpected leakage of the distant TD-SCDMA cell may result in an artificial hole or lack of coverage by the ubiquitous GSM network. The lack of coverage may occur in the process of inter-RAT reselection, due to the wrong set of GSM neighbor cells in the GSM neighbor information available to the UE.

Conventional implementations limit the set of neighbor cells available to the UE to current neighbor cells in a currently received neighbor information. In this implementation, previously received neighbor information are cleared when the currently received neighbor information is received. However, clearing the previously received neighbor information is unnecessary and does not address the issue of unexpected leakage of a distant TD-SCDMA cell having distant GSM neighbor cells.

Offered is a method and system for expanding the neighbor list available to the UE to avoid neighbor information error caused by the unexpected leakage of distant TD-SCDMA cells. The neighbor list, may be expanded by combining previously received neighbor information with currently received neighbor information. Although different RATs, such as GSM and TD-SCDMA, have independent network topology, the neighbor list from one RAT cell to any bordering or neighbor cells may have a large subset of neighbor cells in common Thus, when the UE reselects a distant TD-SCDMA cell that unexpectedly stretches into the coverage boundary for the UE and brings a current set of distant GSM neighbor cells or indicates that there are no GSM neighbor cells, an expanded neighbor list implementation may be triggered to incorporate previously received neighbor information to the current neighbor information. In this aspect, the UE saves previously received neighbor information of one or more recently camped TD-SCDMA cells to reduce the probability of missing any GSM neighbor cells. In addition, the UE may maintain an expanded neighbor list based at least in part on the neighbor cells in the currently received neighbor information as well as neighbor cells in the previously received neighbor information of the one or more recently camped TD-SCDMA cells. Thus, when a UE loses TD-SCDMA service, the UE may perform a proprietary selection based on the neighbor cells of the previously received neighbor information to reduce the out of service time.

In one aspect of the disclosure, the expanded neighbor list implementation may be triggered based at least in part on a difference between neighbor cells of the previously received neighbor information and neighbor cells of the currently received neighbor information. For example, the expanded list implementation is triggered when the difference is above or below a predetermined percentage or threshold.

One way to maintain the expanded neighbor list is to set a fixed size of the expanded neighbor list to accommodate at least a portion of the neighbor cells in the previously received neighbor information. In one aspect, neighbor cells are dropped off the expanded neighbor list based on their length of time on the expanded neighbor list. For example, the neighbor cells that have been on the list the longest are the first to be dropped off the expanded neighbor list. Neighbor cells may be dropped off the expanded neighbor list to accommodate newer neighbor cells.

In one aspect of the disclosure, one or more of the neighbor cells may be added to the expanded neighbor list based at least in part on whether the signal strength of the neighbor cells meet a threshold. For example, a neighbor cell of the previously received neighbor information may be added to the expanded neighbor list when the signal strength of the neighbor cell is above the threshold. Having an expanded neighbor list with cells that meet the threshold reduces the number of unnecessary IRAT measurements by limiting or avoiding measurement of cells that fail to meet the threshold. The expanded list implementation may be applied to intra and inter-frequency neighbor cell information of the same RAT for cell reselection or reacquisition of services within the RAT. In one aspect of the disclosure, one or more of the neighbor cells may be added to the expanded neighbor list based at least in part on the radio access technology of the at least one neighbor cell.

As shown in FIG. 5 a UE may receive a current neighbor information, as shown in block 502. The UE may maintain an expanded neighbor list by combining previously received neighbor information with currently received neighbor information, as shown in block 504.

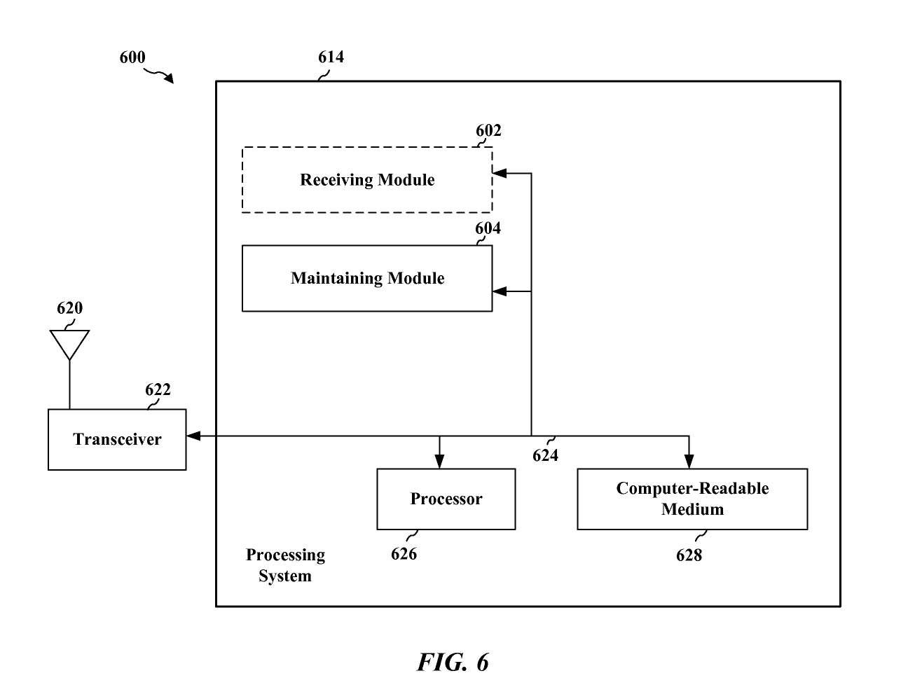

FIG. 6 is a diagram illustrating an example of a hardware implementation for an apparatus 600 employing a neighbor base station signal measurement system 614. The neighbor base station signal measurement system 614 may be implemented with a bus architecture, represented generally by a bus 624. The bus 624 may include any number of interconnecting buses and bridges depending on the specific application of the neighbor base station signal measurement system 614 and the overall design constraints. The bus 624 links together various circuits including one or more processors and/or hardware modules, represented by a processor 626, a receiving module 602 and a maintaining module 604, and a computer-readable medium 628. The bus 624 may also link various other circuits such as timing sources, peripherals, voltage regulators, and power management circuits, which are well known in the art, and therefore, will not be described any further.

The apparatus includes the neighbor base station signal measurement system 614 coupled to a transceiver 622. The transceiver 622 is coupled to one or more antennas 620. The transceiver 622 provides a means for communicating with various other apparatus over a transmission medium. The neighbor base station signal measurement system 614 includes the processor 626 coupled to the computer-readable medium 628. The processor 626 is responsible for general processing, including the execution of software stored on the computer-readable medium 628. The software, when executed by the processor 626, causes the neighbor base station signal measurement system 614 to perform the various functions described supra for any particular apparatus. The computer-readable medium 628 may also be used for storing data that is manipulated by the processor 626 when executing software. The neighbor base station signal measurement system 614 further includes the receiving module 602 for receiving a current neighbor information and the maintaining module 604 for maintaining an expanded neighbor list by combining previously received neighbor information with currently received neighbor information. The receiving module 602 and the maintaining module 604 may be software modules running in the processor 626, resident/stored in the computer-readable medium 628, one or more hardware modules coupled to the processor 626, or some combination thereof. The neighbor base station signal measurement system 614 may be a component of the UE 350 and may include the memory 392 and/or the processor 390.

In one configuration, the apparatus 600 for wireless communication includes means for receiving. The means may be the receiving module 602, the receiver 354, transceiver 622, antenna 352/620, the receive frame processor 360, the receive processor 370, the channel processor 394, the neighbor list expanding module 391, the memory 392, the processor 390 and/or the neighbor base station signal measurement system 614 of the apparatus 600 configured to perform the functions recited by the measuring and recording means. As described above, the neighbor base station signal measurement system 614 may include the memory 392 and/or the processor 390. In another aspect, the aforementioned means may be any module or any apparatus configured to perform the functions recited by the aforementioned means.

In one configuration, the apparatus 600 for wireless communication includes means for maintaining. The means may be the maintaining module 604, the neighbor list expanding module 391, the memory 392, the processor 390 and/or the neighbor base station signal measurement system 614 of the apparatus 600 configured to perform the functions recited by the means. As described above, the neighbor base station signal measurement system 614 may include the memory 392 and/or the processor 390. In another aspect, the aforementioned means may be any module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
maintaining an expanded neighbor list by combining previously received neighbor information and currently received neighbor information, the previously received neighbor information including a list of neighbor cells around a previously camped serving cell, the currently received neighbor information including a list of neighbor cells around a current serving cell.

2. The method of claim 1, in which the maintaining further comprises maintaining the expanded neighbor list to reduce service delay.

3. The method of claim 2, further comprising selecting a new serving cell from the previously received neighbor information.

4. The method of claim 1, in which the maintaining further comprises maintaining a fixed size of the expanded neighbor list to accommodate at least a portion of the previously received neighbor information.

5. The method of claim 1, in which at least one neighbor cell of the previously received neighbor information is included in the expanded neighbor list based at least in part on whether a signal strength of the at least one neighbor cell meets a threshold.

6. The method of claim 1, in which at least one neighbor cell of the previously received neighbor information is included in the expanded neighbor list based at least in part on a radio access technology of the at least one neighbor cell.

7. The method of claim 1, further comprising triggering the expanded neighbor list based at least in part on a difference between neighbor cells in the previously received neighbor information and the currently received neighbor information.

8. An apparatus for wireless communication, comprising:
means for receiving current neighbor information, the current neighbor information including a list of neighbor cells around a current serving cell; and
means for maintaining an expanded neighbor list by combining previously received neighbor information and the current neighbor information, the previously received neighbor information including a list of neighbor cells around a previously camped serving cell.

9. The apparatus of claim 8, in which the means for maintaining further comprises means for maintaining the expanded neighbor list to reduce service delay.

10. The apparatus of claim 8, in which the means for maintaining further comprises means for maintaining a fixed size of the expanded neighbor list to accommodate at least a portion of the previously received neighbor information.

11. An apparatus for wireless communication, comprising:
a memory; and
at least one processor coupled to the memory and configured:
to maintain an expanded neighbor list by combining previously received neighbor information and currently received neighbor information, the previously received neighbor information including a list of neighbor cells around a previously camped serving cell, the currently received neighbor information including a list of neighbor cells around a current serving cell.

12. The apparatus of claim 11, in which the at least one processor is further configured to maintain by maintaining the expanded neighbor list to reduce service delay.

13. The apparatus of claim 12, in which the at least one processor is further configured to select a new serving cell from the previously received neighbor information.

14. The apparatus of claim 11, in which the at least one processor is further configured to maintain by maintaining a fixed size of the expanded neighbor list to accommodate at least a portion of the previously received neighbor information.

15. The apparatus of claim 11, in which the at least one processor is further configured to include at least one neighbor cell of the previously received neighbor information in the expanded neighbor list based at least in part on whether a signal strength of the at least one neighbor cell meets a threshold.

16. The apparatus of claim 11, in which the at least one processor is further configured to include at least one neighbor cell of the previously received neighbor information in the expanded neighbor list based at least in part on a radio access technology of the at least one neighbor cell.

17. The apparatus of claim 11, in which the at least one processor is further configured to trigger the expanded neighbor list based at least in part on a difference between neighbor cells in the previously received neighbor information and the currently received neighbor information.

18. A computer program product for wireless communications in a wireless network, comprising:
a non-transitory computer-readable medium having program code recorded thereon, the program code comprising:
program code to maintain an expanded neighbor list by combining previously received neighbor information and currently received neighbor information, the previously received neighbor information including a list of neighbor cells around a previously camped serving cell, the currently received neighbor information including a list of neighbor cells around a current serving cell.

19. The computer program product of claim 18, in which the program code further comprises code to maintain by maintaining the expanded neighbor list to reduce service delay.

20. The computer program product of claim 19, in which the program code further comprises code to select a new serving cell from the previously received neighbor information.
